(19) United States
(12) Patent Application Publication
(10) Pub. No.: US 2009/0004564 A1
(43) Pub. Date: Jan. 1, 2009

(54) Composite Negative Electrode Active Material, Method For Producing The Same And Non-Aqueous Electrolyte Secondary Battery

(75) Inventors: Sumihito Ishida, Osaka (JP); Hiroaki Matsuda, Osaka (JP); Hiroshi Yoshizawa, Osaka (JP)

Correspondence Address: MCDERMOTT WILL & EMERY LLP, 600 13TH STREET, NW, WASHINGTON, DC, 20005-3096, US

(73) Assignee: MATSUSHITA ELECTRIC INDUSTRIAL CO., LTD., Osaka (JP)

(21) Appl. No.: 11/661,127

(22) PCT Filed: Aug. 23, 2005
(86) PCT No.: PCT/JP2005/015266

§ 371 Date: Feb. 26, 2007

(30) Foreign Application Priority Data
Dec. 22, 2004 (JP) 2004-371255

(51) Int. Cl. H01M 4/54; H01M 4/58; H01M 4/88

(52) U.S. Cl. 429/219; 429/218.1; 502/101

(57) ABSTRACT

A composite negative electrode active material including silicon oxide particles represented by SiOₓ (0.05<x<1.95) capable of charging and discharging lithium, carbon nanofibers (CFN) bonded to the surface of the silicon oxide particles and a catalyst element for promoting the growth of carbon nanofiber. For example, Au, Ag, Pt, Ru, Ir, Cu, Fe, Co, Ni, Mo or Mn is preferred as the catalyst element.

### TECHNICAL FIELD

The present invention relates to a composite negative electrode active material comprising improved silicon oxide particles represented by SiOₓ (0.05<x<1.95) that is capable of charging and discharging lithium, specifically, a composite negative electrode active material comprising silicon oxide particles and carbon nanofibers bonded to the surface thereof. Further, the present invention relates to a non-aqueous electrolyte secondary battery having excellent cycle characteristics and high reliability.

### BACKGROUND ART

As electronic devices have been progressively made portable and cordless, there has been growing expectation for non-aqueous electrolyte secondary batteries that are small in size and light in weight and have a high energy density. At present, carbon materials such as graphite come into practical use as negative electrode active materials for non-aqueous electrolyte secondary batteries. Theoretically, graphite can absorb lithium in a proportion of one lithium atom to six carbon atoms.

Graphite has a theoretical capacity density of 372 mAh/g; however, the actual discharge capacity density is degraded to be approximately 310 to 330 mAh/g because of the capacity losses such as irreversible capacity loss, etc. It is difficult to obtain a carbon material that can absorb or desorb lithium ions having a capacity density equal to or higher than the above-described capacity density. However, batteries having higher energy densities have been demanded.

Under these circumstances, negative electrode active materials having a theoretical capacity density higher than those of carbon materials have been proposed. Promising among these materials are elementary substances, oxides and alloys of the elements (such as Si, Sn and Ge) capable of forming an alloy with lithium.

However, active materials comprising elementary substances, oxides or alloys such as Si, Sn and Ge are very low in electronic conductivity, and hence are not practically usable because of increased internal resistance of batteries unless these active materials are mixed with a conductive material.

Accordingly, the use of fine-particle graphite powder and carbon black as conductive materials has been examined (Non-patent Document 1). The use of these conductive materials improves the initial charge/discharge characteristics of batteries.

Si and oxides thereof are particularly poor in conductivity, and hence the carbon coating of the surface of these materials has been proposed. The carbon coating is carried out by the CVD (chemical vapor deposition) method. The carbon coating ensures the electronic conductivity, and reduces the electrode plate resistance before charging (Patent Documents 2 and 3). It has also been proposed to use carbon nanotubes known to exhibit high conductivity as a conductive material (Patent Document 4).

It has also been proposed to improve the conductivity within active material particles. For example, it has been proposed to add elements such as Cr, B, P and the like to active materials. It has also been proposed to mix carbon nanotubes with active materials using a ball mill (Non-patent Document 2).

It has been further proposed to form a thin membrane of Si, Sn or Ge, or of an oxide thereof directly on a current collector instead of using a conductive material (Patent Document 5).

Patent Document 1: Japanese Laid-Open Patent Publication No. Hei 6-325765

Patent Document 2: Japanese Laid-Open Patent Publication No. 2002-42806

Patent Document 3: Japanese Laid-Open Patent Publication No. 2004-47404

Patent Document 4: Japanese Laid-Open Patent Publication No. 2004-80019

Patent Document 5: Japanese Laid-Open Patent Publication No. Hei 11-135115

Non-patent Document 1: Zenhachi Kokumi (Ed.), “Latest Technologies of New Secondary Battery Materials,” CMC Publishing Co., Ltd., Mar. 25, 1997, pp. 91-98.

Non-patent Document 2: “Electrochemistry,” 2003, Vol. 71. No. 12, pp. 1105-1107.

### DISCLOSURE OF THE INVENTION

### Problems to Be Solved by the Invention

As described above, in the negative electrodes for non-aqueous electrolyte secondary batteries, substitutes for carbon materials have been examined. However, such substitutes are poor in conductivity, and satisfactory charge/discharge characteristics cannot be obtained when used each alone. Accordingly, use of conductive materials has been proposed for the purpose of constructing electronically conductive network, and carbon coating of the surface of active materials has also been proposed.

However, negative electrode active materials repeat the alloying reaction with lithium and the lithium separation reaction in the charge/discharge cycles. Consequently, the active material particles repeat expansion and contraction to gradually break the electronically conductive network among the particles. Thus, the internal resistance in a battery is increased, making it difficult to realize satisfactory cycle characteristics.

Even when an element such as Cr, B or P is added to the active material, the electronically conductive network among the active material particles is gradually broken. Even when the active material and carbon nanotubes are mixed together using a ball mill, the electronically conductive network among the active material particles is gradually broken. Consequently, no satisfactory cycle characteristics can be obtained.

In the case where a thin membrane of Si, Sn or Ge or of an oxide thereof is directly formed on the current collector, the thin membrane expands in the direction of the thickness of the electrode plate. This causes buckling in the electrode assembly or a crack in the current collector, causing extreme degradation in capacity. Herein, the electrode assembly is formed by winding a positive electrode and a negative electrode with a separator interposed therebetween.

Further, in the case where a thin membrane of silicon oxide is formed on the current collector, hydrogen fluoride (HF) and silicon oxide contained in the electrolyte react to produce moisture. The presence of moisture in the battery causes continuous gas generation. This eventually activates the safety valve in a cylindrical battery to shut off the current. In a rectangular battery, this swells the battery, and the reliability is reduced.

### Means for Solving the Problems

The present invention relates to a composite negative electrode active material comprising silicon oxide particles represented by SiOₓ (0.05<x<1.95), carbon nanofibers (CNF) bonded to the surface of the silicon oxide particles and a catalyst element for promoting the growth of carbon nanofiber.

It is preferable that the catalyst element used herein is at least one selected from the group consisting of Au, Ag, Pt, Ru, Ir, Cu, Fe, Co, Ni, Mo and Mn.

The composite negative electrode active material may exclusively include the silicon oxide particles, the carbon nanofibers and the catalyst element; or may additionally include other components as long as the other components do not impair the function of the composite negative electrode active material. Examples of such other components may include a conductive polymer.

The composite negative electrode active material of the present invention is obtained by, for example, allowing the carbon nanofibers to grow on the surface of the silicon oxide particles where the catalyst element is present. Herein, the catalyst element may be present at least in the surface of the silicon oxide particles; however, it may be present inside the silicon oxide particles.

At least one end of the carbon nanofiber is bonded to the surface of the silicon oxide particle. However, both ends of the carbon nanofibers may be bonded to the surface of the silicon oxide particles.

When the catalyst element is not separated from the silicon oxide particles despite the growth of carbon nanofiber, the catalyst element is located at the fixed end of the carbon nanofibers. In other words, the catalyst element is located at the site of bonding between the carbon nanofibers and the silicon oxide particles. In this case, there is obtained a composite negative electrode active material in which the catalyst element is carried on the silicon oxide particles.

To the contrary, when the catalyst element is separated from the silicon oxide particles as the carbon nanofibers grow, the catalyst element is located at the tip of the carbon nanofibers, namely, the free end thereof. In this case, there is obtained a composite negative electrode active material in which one end of the carbon nanofibers is bonded to the surface of the silicon oxide particles, and the other end of the carbon nanofibers carries the catalyst element.

In the composite negative electrode active material, the carbon nanofibers having the catalyst element at the fixed end thereof and the carbon nanofibers having the catalyst element at the free end thereof may be present concomitantly with each other. Additionally, the carbon nanofibers having the catalyst element at the fixed end thereof and the carbon nanofibers having the catalyst element at the free end thereof may be simultaneously bonded to one silicon oxide particle.

In a preferred embodiment of the present invention, one end of the carbon nanofiber is bonded to Si on the surface of the silicon oxide particle to form SiC (silicon carbide). In this case, the carbon nanofibers are directly bonded to the surface of the silicon oxide particles without involving the intermediary of a resin component. The size of the crystal gain (crystallite) of SiC is preferably 1 nm to 100 nm.

When SiC is formed, the X-ray diffraction spectrum of the composite negative electrode active material has a diffraction peak attributed to the (111) face of SiC. In this case, the size of the crystal gain (crystallite) of SiC can be determined by the Scherrer method using the half-width of the diffraction peak attributed to the (111) face.

It is desired that the catalyst element displays satisfactory catalytic action until the growth of carbon nanofiber is completed. For that purpose, it is preferable that the catalyst element is present in a metallic state in the surface layer of the silicon oxide particles and/or at the free end of the carbon nanofibers.

The catalyst element (hereinafter referred to as catalyst particles) is preferably present in a state of particles having a particle size of 1 nm to 1000 nm in the surface layer of the silicon oxide particles and/or at the free end of the carbon nanofibers. The size of the catalyst particles can be measured on the basis of the SEM observation, the TEM observation or the like.

The catalyst particles may exclusively include at least one metal element selected from the group consisting of Au, Ag, Pt, Ru, Ir, Cu, Fe, Co, Ni, Mo and Mn, or may additionally include other elements.

The catalyst particles may be in a state of metallic particles, or alternatively in a state of metal oxide particles. The catalyst particles may be particles containing a metal and a metal oxide. Two or more types of catalyst particles may be used together. It is desired that the catalyst particles be present in a state of metallic particles until the growth of carbon nanofiber is completed. And after the completion of the growth of carbon nanofiber, it is desired that at least the surface of the catalyst particles be oxidized.

The fiber length of the carbon nanofibers is preferably 1 nm to 1 mm. In view of improving the electronic conductivity of the composite negative electrode active material, the carbon nanofibers preferably include fine fibers having a diameter of 1 nm to 40 nm, and more preferably simultaneously include fine fibers having a diameter of 1 nm to 40 nm and large fibers having a diameter of 40 to 200 nm. The fiber length and the fiber diameter can be measured on the basis of the SEM observation, the TEM observation or the like.

The carbon nanofibers may include at least one selected from the group consisting of tubular carbon, accordion-shaped carbon, plate-shaped carbon and herringbone-shaped carbon. The carbon nanofibers may exclusively include at least one selected from the above described group, or may additionally include carbon nanofibers in other states.

It should be noted that silicon oxide is more advantageous than elementary silicon as an active material for the reasons as described below.

Elementary silicon is regarded as promising as an active material of high capacity. However, the reaction in which elementary silicon electrochemically absorbs and desorbs lithium is accompanied with an extremely complex change in crystal structure. As the reaction proceeds, the composition and the crystal structure of silicon change among those of Si (crystal structure: Fd3m), LiSi (crystal structure: I41/a), Li₂Si (crystal structure: C2/m), Li₇Si₂ (Pbam) and Li₂₂Si₅ (F23). The complex changes in the crystal structure expand the volume of Si by a factor of approximately four. Consequently, as the charge/discharge cycle is repeated, the destruction of silicon particle proceeds. Additionally, the formation of bonds between lithium and silicon impairs the lithium-insertion sites initially possessed by silicon, resulting in marked degradation of the cycle life.

For the above described problems, there has also been proposed the application of microcrystalline silicon or amorphous silicon. However, an effect obtained by such an application is limited to that of suppressing the destruction of particle to some extent. Consequently, such an application cannot suppress the destruction of the lithium-insertion sites caused by the bonding between silicon and lithium.

On the other hand, in the case of silicon oxide, the silicon atom is covalently bonded to the oxygen atom. Accordingly, for the purpose of bonding Si to lithium, it is necessary to break the covalent bond between the silicon atom and the oxygen atom. Consequently, even when Li is inserted, suppression of destruction of the silicon oxide framework tends to be observed. In other words, it is interpreted that the reaction between silicon oxide and Li proceeds while the silicon oxide framework is being maintained.

Further, in the case of silicon oxide particles, the fixation of the catalyst element is achieved more surely compared with the case of elementary silicon particles. This is conceivably because the oxygen atoms located on the surface of the silicon oxide particles are bonded to the catalyst element. Further, it is interpreted that the electron attracting effect of the oxygen located on the surface of the particles improves the reduction performance of the catalyst element into a metal, and consequently, a high catalytic activity can be obtained even under mild reduction conditions.

The present invention also relates to a method for producing a composite negative electrode active material, the method including steps of: A) causing silicon oxide particles represented by SiOₓ (0.05<x<1.95) to carry a catalyst element for promoting the growth of carbon nanofiber; B) growing carbon nanofibers on the surface of the silicon oxide particles carrying the catalyst element in an atmosphere comprising a carbon-containing gas (a gas of a carbon atom containing compound); and C) baking the silicon oxide particles with the carbon nanofibers bonded thereto at 400° C. or higher and 1400° C. or lower in an inert gas atmosphere.

In the step C, when the baking temperature is lower than 400° C., a composite negative electrode active material having a large irreversible capacity in which a large number of surface functional groups are present may be formed. On the other hand, when the baking temperature exceeds 1400° C., a large amount of SiOₓ may change to SiC, causing reduction in the capacity of the composite negative electrode active material.

The production method of the present invention particularly prefers, for example, a case in which the catalyst element is Ni, the carbon-containing gas is ethylene and the carbon nanofibers are of a herringbone shape. This is ascribable to the fact that the herringbone-shaped carbon is formed of a low crystalline carbon, and hence is high in flexibility and easily alleviates the expansion and contraction of the active material associated with the charge/discharge operation.

The present invention further relates to a non-aqueous electrolyte secondary battery comprising a negative electrode including the above described composite negative electrode active material, a positive electrode capable of charge and discharge, a separator interposed between the positive electrode and the negative electrode, and a non-aqueous electrolyte.

### EFFECT OF THE INVENTION

In the composite negative electrode active material of the present invention, carbon nanofibers are bonded to the surface of the silicon oxide particles represented by SiOₓ (0.05<x<1.95). Accordingly, a negative electrode including the composite negative electrode active material is high in electronic conductivity, making it possible to obtain a battery having excellent initial charge/discharge characteristics.

The carbon nanofibers and the silicon oxide particles are chemically bonded. Accordingly, even when the silicon oxide particles repeat expansion and contraction during the charge/discharge reaction, the contact between the carbon nanofibers and the silicon oxide particles is constantly maintained. Accordingly, the use of the composite negative electrode active material of the present invention provides a battery excellent in charge/discharge cycle characteristics.

The carbon nanofibers serve as a buffer layer to absorb the stress caused by the expansion and contraction of the silicon oxide particles. Accordingly, buckling is suppressed even in an electrode assembly formed by winding the positive electrode and the negative electrode with a separator interposed therebetween. The cracking of current collectors caused by buckling is also suppressed.

The carbon nanofibers grown by vapor phase reaction include some carbon nanofibers that electrochemically insert and extract lithium. The carbon nanofibers with lithium inserted thereto trap hydrogen fluoride that is present or generated in the battery. When trapped, the hydrogen fluoride is converted into a dilithium hexaflurosilicon compound (Li₂SiF₆). This suppresses gas generation due to the presence of hydrogen fluoride, making it possible to obtain a highly reliable battery.

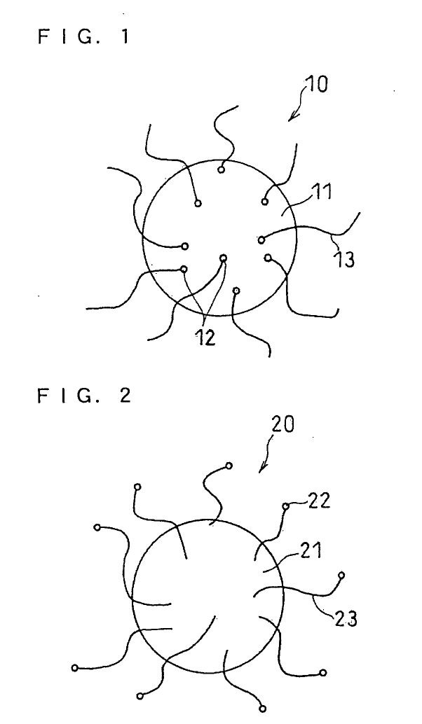

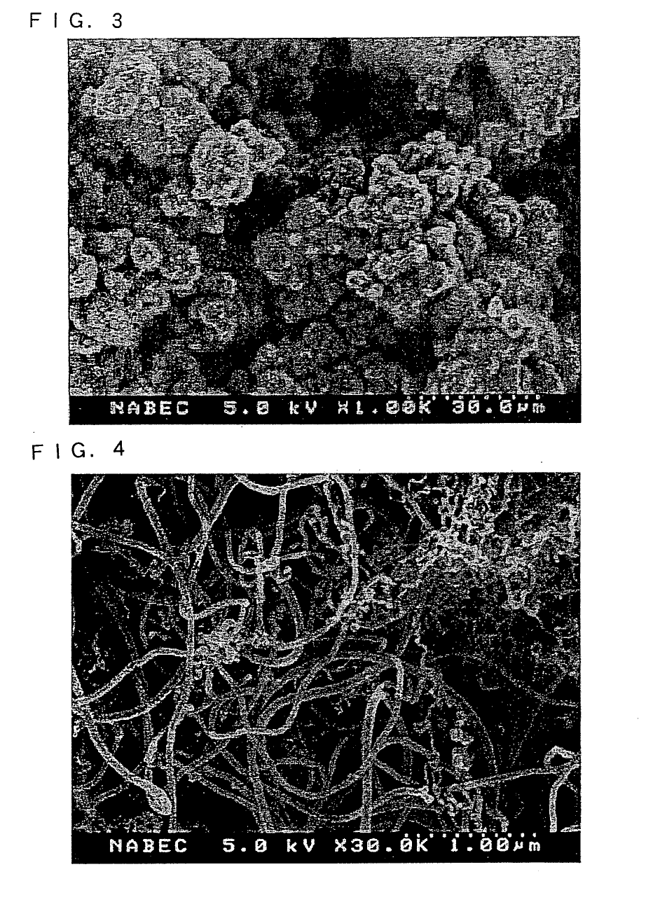

### BRIEF DESCRIPTION OF THE DRAWINGS

[FIG. 1] A schematic view illustrating the structure of an example of a composite negative electrode active material of the present invention;

[FIG. 2] A schematic view illustrating the structure of another example of a composite negative electrode active material of the present invention;

[FIG. 3] A 1000-fold magnified SEM photograph of the composite negative electrode active material according to Example 1; and

[FIG. 4] A 30000-fold magnified SEM photograph of the composite negative electrode active material according to Example 1.

### BEST MODE FOR CARRYING OUT THE INVENTION

The composite negative electrode active material according to the present invention comprises silicon oxide particles represented by SiOₓ (0.05<x<1.95), carbon nanofibers bonded to the surface of the silicon oxide particles and a catalyst element for promoting the growth of carbon nanofiber.

The silicon oxide particle is more preferably formed of a single particle rather than a granulated body formed of two or more particles. A single particle hardly undergoes the collapse caused by the expansion and contraction during charge and discharge. In view of suppressing the cracking of the particle as completely as possible, the mean particle size of the silicon oxide particle formed of a single particle is preferably in a range from 1 to 30 μm. A granulated body formed of two or more particles comes to be larger in particle size than the above described range, and hence sometimes collapses by being subjected to the stress of the expansion and contraction during charge and discharge.

The silicon oxide particles represented by SiOₓ (0.05<x<1.95) are capable of charging and discharging lithium and constitutes an electrochemically active phase. In SiOₓ (0.05<x<1.95), when the value x is less than 0.05, a steep degradation in cycle characteristics is observed; and when the value x exceeds 1.95, reduction in discharge capacity is observed.

The silicon oxide particle may be a pure particle composed of silicon and oxygen only, or may additionally include a small amount of impurities or additive element. However, the content of element other than silicon and oxygen in the silicon oxide particle is preferably less than 5% by weight.

Although the particle size of the silicon oxide particle is not particularly limited, a mean particle size is preferably in a range from 1 to 30 μm, and more preferably in a range from 3 to 10 μm. The mean particle size in such a range facilitates the process of fabricating an electrode plate.

The carbon nanofibers bonded to the surface of the silicon oxide particles are synthesized using the silicon oxide particles having the catalyst element, which promotes the growth of carbon nanofiber, at least in the surface layer thereof. The silicon oxide particles as such may be prepared by causing the silicon oxide particles to carry the catalyst element in various methods.

As the catalyst element, it is preferable to use at least one selected from the group consisting of Au, Ag, Pt, Ru, Ir, Cu, Fe, Co, Ni, Mo and Mn. Elements other than these may be used in combination. The catalyst element located on the outermost surface of the silicon oxide particles is typically in a metallic state or a state of an oxide.

The catalyst element in a metallic state provides an active site for growing the carbon nanofibers. In other words, when the silicon oxide particles on the surface of which the catalyst element is exposed in a metallic state is introduced into a high temperature atmosphere that contains a raw material gas for the carbon nanofibers, the growth of carbon nanofiber proceeds. When no catalyst element is present on the surface of the silicon oxide particles, no growth of carbon nanofiber is found.

When the carbon nanofibers have been grown directly on the surface of the silicon oxide particles, the bond between the surface of the silicon oxide particles and the carbon nanofibers does not involve the intermediary of a resin component, but is nothing else than a chemical bond. For this reason, even when the silicon oxide particles themselves expand or contract greatly, the bonds between the silicon oxide particles and the carbon nanofibers are not easily broken. Consequently, occurrence of breaks in the electronically conductive network can be reduced. Accordingly, the resistance to the current collection becomes small to ensure a high electronic conductivity. Thus, the battery also is expected to have satisfactory cycle characteristics.

The catalyst element is preferably present in a metallic state until the growth of carbon nanofiber is completed for allowing the catalyst element to display a satisfactory catalytic action. Usually, the catalyst element is present preferably in a state of catalyst particles having a particle size of 1 nm to 1000 nm, and more preferably in a state of catalyst particles having a particle size of 10 to 100 nm.

FIG. 1 is a schematic view illustrating the structure of an example of the composite negative electrode active material of the present invention.

The composite negative electrode active material 10 includes the silicon oxide particle 11, the catalyst particles 12 located on the surface of the silicon oxide particle 11, and the carbon nanofibers 13 grown with the catalyst particles 12 as the starting point. The composite negative electrode active material as such is obtained when the catalyst element is not separated from the silicon oxide particles even when the carbon nanofibers have been grown. In this case, the catalyst particles are present at the bonding sites between the silicon oxide particles and the carbon nanofibers, namely, at the fixed ends of the carbon nanofibers.

FIG. 2 is a schematic view illustrating the structure of another example of the composite negative electrode active material of the present invention.

The composite negative electrode active material 20 includes the silicon oxide particle 21, the carbon nanofibers 23 one end of which is bonded to the surface of the silicon oxide particle 21, and the catalyst particles 22 carried on the other end of the carbon nanofibers 23. The composite negative electrode active material as such is obtained when the catalyst particles are separated from the silicon oxide particles according to the growth of carbon nanofibers. In this case, the catalyst particles are present at the tips, namely, the free ends of the carbon nanofibers.

The method for causing the catalyst particles to be carried on the surface of the silicon oxide particles is not particularly limited. Description will be hereinafter made on one of the examples of such a method. Although one conceivable method is to mix solid catalyst particles with silicon oxide particles, a preferable method is to soak silicon oxide particles in a solution of a metal compound to be a raw material for the catalyst particles. The solvent is removed from the silicon oxide particles having been soaked in the solution, and according to the necessity, the particles are subsequently heated. In this way, it is possible to obtain silicon oxide particles that carry on the surface thereof catalyst particles having a particle size of 1 nm to 1000 nm, preferably 10 to 100 nm uniformly and in a highly dispersed state.

It is extremely difficult to form catalyst particles having a particle size of less than 1 nm. On the other hand, when the particle size of catalyst particles exceeds 1000 nm, the formed catalyst particles are extremely nonuniform in size, and the growth of carbon nanofiber becomes difficult. And in some cases, electrodes excellent in conductivity cannot be obtained.

Examples of the metal compound for obtaining the solution may include nickel nitrate hexahydrate, cobalt nitrate hexahydrate, iron nitrate nonahydrate, copper nitrate trihydrate, manganese nitrate hexahydrate and hexaammonium heptamolybdate tetrahydrate; however, such metal compounds are not limited to these examples.

The solvent for the solution is selected in consideration of the solubility of the compound and the compatibility of the solvent with the electrochemically active phase. A preferable solvent is selected from, for example, water, an organic solvent, and a mixture composed of water and an organic solvent. As an organic solvent, there may be used, for example, ethanol, isopropyl alcohol, toluene, benzene, hexane, tetrahydrofuran and the like.

The amount of the catalyst particles to be carried on the silicon oxide particles is preferably 0.01 part by weight to 10 parts by weight, and more preferably 1 part by weight to 3 parts by weight, per 100 parts by weight of the silicon oxide particles. When the amount of the catalyst particles is too small, sometimes it takes a long time to grow carbon nanofibers, resulting in degrading the production efficiency. On the other hand, when the amount of the catalyst particles is too large, agglomeration of the catalyst element results in growing of carbon nanofibers that are nonuniform and large in fiber diameter. This leads to the degradation of the conductivity and the active material density of the electrodes. And in some cases, the proportion of the electrochemically active phase becomes relatively too small, and this makes it difficult to fabricate a high-capacity electrode material using the composite negative electrode active material.

In the composite negative electrode active material, it is preferable that one end of the carbon nanofibers is bonded to Si on the surface of the silicon oxide particles to form SiC (silicon carbide). It is considered that expansion and contraction repeated as the charge/discharge reaction proceeds generates a stress, which is largest at the surface of the silicon oxide particles. Formation of SiC at the bonding sites between the silicon oxide particles and the carbon nanofibers can suppress occurrence of breaks in the electronically conductive network on the surface of the silicon oxide particles where the stress generated is largest. Hence, satisfactory cycle characteristics can be obtained.

When SiC is formed, the X-ray diffraction spectrum of the composite negative electrode active material has a diffraction peak attributed to the (111) face of SiC. The size of the crystal gain (crystallite) of SiC can be determined by obtaining the half-width of the diffraction peak attributed to the (111) face and substituting the obtained value into the Scherrer formula. The crystal grain size of SiC thus obtained is preferably 1 to 100 nm. When the crystal grain size of SiC is less than 1 nm, the bonds between the silicon oxide particles and the carbon nanofibers are considered to be weak. For this reason, in a long term charge/discharge cycle, the degradation in discharge capacity is observed. On the other hand, when the crystal grain size of SiC exceeds 100 nm, excellent cycle characteristics can be obtained. It should be noted, however, that since SiC is of high resistance, the large current discharge characteristics are sometimes degraded.

The fiber length of the carbon nanofibers is preferably 1 nm to 1 mm, and more preferably 500 nm to 500 μm. When the fiber length of the carbon nanofibers is less than 1 nm, the effect of increasing the electrode conductivity becomes too small. On the other hand, when the fiber length exceeds 1 mm, the active material density and the capacity of the electrodes tend to be small. The fiber diameter of the carbon nanofibers is preferably 1 nm to 1000 nm, and more preferably 50 nm to 300 nm.

A part of the carbon nanofibers is preferably composed of fine fibers having a diameter of 1 nm to 40 nm in view of improving the electronic conductivity of the composite negative electrode active material. For example, fine fibers having a diameter of 40 nm or less and large fibers having a diameter of 50 nm or more are preferably included simultaneously, and fine fibers having a diameter of 20 nm or less and large fibers having a diameter of 80 nm or more are more preferably included simultaneously.

The amount of the carbon nanofibers to be grown on the surface of the silicon oxide particles is preferably 5 parts by weight to 150 parts by weight, and more preferably 10 to 100 parts by weight, per 100 parts by weight of the silicon oxide particles. When the amount of the carbon nanofibers is too small, sometimes effects of improving the electrode conductivity and improving the charge/discharge characteristics and the cycle characteristics of a battery cannot be sufficiently attained. Also when the amount of the carbon nanofibers is too large, the active material density and the capacity of the electrode become small, although there are no problems in view of the electrode conductivity, and the charge/discharge characteristics and the cycle characteristics of a battery.

Next, description will be made on the conditions for growing carbon nanofibers on the surface of silicon oxide.

When silicon oxide particles that contain a catalyst element at least in the surface layer thereof are introduced into a high temperature atmosphere that contains a raw material gas for the carbon nanofibers, the growth of carbon nanofiber proceeds. For example, the silicon oxide particles are placed in a ceramic reaction vessel, and the temperature is elevated to high temperatures of 100 to 1000° C., preferably to 700° C. in an inert gas or a gas having a reducing power. Thereafter, a raw material gas for the carbon nanofibers is introduced into the reaction vessel to grow the carbon nanofibers, for a duration of, for example, 1 minute to 10 hours. When the temperature inside the reaction vessel is lower than 100° C., the growth of carbon nanofiber does not occur or the growth is too slow, and hence the productivity is impaired. When the temperature inside the reaction vessel exceeds 1000° C., decomposition of the reaction gas is promoted, and hence the production of the carbon nanofibers becomes difficult.

Preferred as the raw material gas is a mixed gas composed of a carbon-containing gas and hydrogen gas. Usable as the carbon-containing gas are methane, ethane, ethylene, butane, acetylene, carbon monoxide and the like. The mixing ratio of the carbon-containing gas to hydrogen gas is preferably 2:8 to 8:2 in terms of molar ratio (volume ratio). When the catalytic element in a metallic state is not exposed on the surface of the silicon oxide particles, the proportion of the hydrogen gas is controlled to be large to some extent. By doing this, the reduction of the catalyst element and the growth of carbon nanotube can be made to proceed simultaneously.

In order to terminate the growth of carbon nanofiber, the mixed gas composed of a carbon-containing gas and hydrogen gas is replaced with an inert gas, and the interior of the reaction vessel is cooled down to room temperature.

Subsequently, the silicon oxide particles with the carbon nanofibers bonded thereto are baked in an inert gas atmosphere at 400° C. or higher and 1400° C. or lower, preferably at 600° C. or higher and 1000° C. or lower, for a duration of, for example, 30 minutes to 2 hours. Thus, there can be suppressed the irreversible reaction between the electrolyte and the carbon nanofibers that proceeds at the time of initial charging of the battery, and an excellent charge/discharge efficiency can be attained.

When such a baking step is not carried out, or the baking temperature is lower than 400° C., the above described irreversible reaction cannot be suppressed and sometimes the charge/discharge efficiency of a battery is degraded. When the baking temperature exceeds 1400° C., silicon oxide is converted to SiC, which is electrochemically inactive and of high resistance, around the bonding points of the carbon nanofibers and the silicon oxide particles. This consequently causes degradation in the discharge characteristics.

Herein, the crystal grain size of SiC can be controlled by controlling the baking temperature in an inert gas atmosphere of the silicon oxide particles with the carbon nanofibers bonded thereto. When the baking temperature is controlled within 400° C. to 1400° C., the crystal grain size of SiC is controlled within a range from 1 to 100 nm.

The carbon nanofibers may incorporate the catalyst element into the interior thereof in the course of the growth thereof. The carbon nanofibers grown on the surface of the silicon oxide particles sometimes include carbon nanofibers in a tubular state, an accordion-shaped state, a plate-shaped state, and a herringbone-shaped state.

When the carbon nanofibers in a herringbone-shaped state are grown, it is preferable that, for example, a copper-nickel alloy (the molar ratio of copper to nickel being 3:7) is used as catalyst, and the reaction is carried out at temperatures of 550 to 650° C. Ethylene gas or the like is preferably used as the carbon-containing gas in the raw material gas. The mixing ratio of the carbon-containing gas to hydrogen gas is preferably 2:8 to 8:2 in terms of molar ratio (volume ratio).

When carbon nanofibers in a tubular state are grown, it is preferable that, for example, an iron-nickel alloy (the molar ratio of iron to nickel being 6:4) is used as catalyst and the reaction is carried out at temperatures of 600 to 700° C. Carbon monoxide or the like is preferably used as the carbon-containing gas in the raw material gas. The mixing ratio of the carbon-containing gas to hydrogen gas is preferably 2:8 to 8:2 in terms of molar ratio (volume ratio).

When carbon nanofibers in a plate-shaped state are grown, it is preferable that, for example, iron is used as catalyst, and the reaction is carried out at temperatures of 550 to 650° C. Carbon monoxide or the like is preferably used as the carbon-containing gas in the raw material gas. The mixing ratio of the carbon-containing gas to hydrogen gas is preferably 2:8 to 8:2 in terms of molar ratio (volume ratio).

It is to be noted that the herringbone-shaped carbon is preferable in that it is formed of a low crystalline carbon, and hence is highly flexible to easily alleviate the expansion and contraction of the active material associated with the charge/discharge operation. Carbon nanofibers in a tubular state and carbon nanofibers in a plate-shaped state have higher crystallinity than carbon nanofibers in a herringbone-shaped state, and are consequently suitable for highly densifying electrode plates.

Next, description will be made on the negative electrodes for non-aqueous electrolyte secondary batteries that contain the above described composite negative electrode active material. The composite negative electrode active material of the present invention contains silicon oxide particles, and is therefore suitable for producing negative electrodes including a negative electrode material mixture containing a resin binder as well as the composite negative electrode active material, and a negative electrode current collector carrying the negative electrode material mixture. The negative electrode material mixture may further contain a conductive material, a thickener including carboxymethyl cellulose (CMC), and the like as the optional components in addition to the composite negative electrode active material and the resin binder as long as these optional components do not significantly impair the advantageous effects of the present invention. As the binder, there are preferably used fluorocarbon resins such as polyvinylidene fluoride (PVDF), or rubber-like resins such as styrene-butadiene rubber (SBR). As the conductive material, carbon black and the like are preferably used.

The negative electrode material mixture is mixed with a liquid component to be formed into slurry. The slurry thus obtained is coated on both sides of a current collector, and then dried. Thereafter, the electrode material mixture carried on the current collector is rolled together with the current collector and the rolled product is cut to a predetermined size to yield a negative electrode. The method described herein is only an example, and the negative electrode may be fabricated by any other methods.

An electrode assembly is constructed by using the obtained negative electrode, a positive electrode and a separator. Although no particular constraint is imposed on the positive electrode, a positive electrode containing a lithium-containing transition metal oxide such as lithium cobalt oxide, lithium nickel oxide, lithium manganese oxide, or the like as a positive electrode active material is preferably used. For the separator, microporous film made of polyolefin resin is preferably used, but no particular constraint is imposed on the separator.

The electrode assembly is housed together with a non-aqueous electrolyte in a battery case. For the non-aqueous electrolyte, there is generally used a non-aqueous solvent in which a lithium salt is dissolved. No particular constraint is imposed on the lithium salt, but for example, LiPF₆, LiBF₄ and the like are preferably used. No particular constraint is imposed on the non-aqueous solvent, but there are preferably used, for example, carbonic acid esters such as ethylene carbonate, propylene carbonate, dimethyl carbonate, diethyl carbonate and ethyl methyl carbonate.

In the following, the present invention will be described specifically in accordance with Examples and Comparative Examples, but the below described Examples exemplify only a part of the embodiments of the present invention and the present invention is not limited to these Examples.

### EXAMPLE 1

In 100 g of ion-exchanged water, 1 g of iron nitrate nonahydrate (guaranteed grade) manufactured by Kanto Chemical Co., Inc. (in the following, the same is used as iron nitrate nonahydrate) was dissolved. The solution thus obtained was mixed with silicon oxide (SiO) pulverized to a particle size of 10 μm or less, manufactured by Kojundo Chemical Laboratory Co., Ltd. As a result of analysis of SiO used herein in accordance with the weight analysis method (JIS Z2613), it was found that the molar ratio of 0/Si was 1.01. The mixture of the silicon oxide particles and the solution was stirred for 1 hour, and then the water was removed with an evaporator to cause the silicon oxide particles to carry iron nitrate on the surface thereof.

The silicon oxide particles carrying iron nitrate were placed in a ceramic reaction vessel, and the temperature was increased to 500° C. in the presence of helium gas. Then, the helium gas was replaced with a mixed gas composed of 50% by volume of hydrogen gas and 50% by volume of carbon monoxide gas. The interior of the reaction vessel was maintained at 500° C. for one hour, to grow plate-shaped carbon nanofibers having a fiber diameter of approximately 80 nm and a fiber length of approximately 50 μm on the surface of the silicon oxide particles. Then, the mixed gas was replaced with helium gas and the interior of the reaction vessel was cooled down to room temperature. The amount of the grown carbon nanofibers was 30 parts by weight per 100 parts by weight of the silicon oxide particles.

The iron nitrate carried on the silicon oxide particles was found to be reduced to iron particles having a particle size of approximately 100 nm. The fiber diameter and the fiber length of the carbon nanofibers and the particle size of the iron particles were respectively observed by means of an SEM. The weight of the grown carbon nanofibers was measured from the weight change of the silicon oxide particles between before and after the growth of carbon nanofiber. The SEM observations identified the presence of fine fibers having a diameter of 30 nm or less in addition to fibers having a diameter of approximately 80 nm. A 1000-fold magnified photograph and a 30000-fold magnified photograph of the obtained composite negative electrode active material are shown in FIG. 3 and FIG. 4, respectively.

Thereafter, the composite negative electrode active material made of the silicon oxide particles with the carbon nanofibers bonded thereto was heated to 1000° C. in argon gas, and then baked at 1000° C. for 1 hour to give a composite negative electrode active material A. The composite negative electrode active material A was then subjected to an X-ray diffraction spectrometry to determine a half-width of the diffraction peak attributed to the (111) face of SiC. The crystal grain size of SiC calculated using the half-width value and the Scherrer formula was 30 nm.

### EXAMPLE 2

The same operations as in Example 1 were carried out except that 1 g of nickel nitrate hexahydrate (guaranteed grade) manufactured by Kanto Chemical Co., Inc. (in the following, the same is used as nickel nitrate hexahydrate) was dissolved in 100 g of ion-exchanged water in place of 1 g of iron nitrate nonahydrate. As a result, a composite negative electrode active material B made of silicon oxide particles with herringbone-shaped carbon nanofibers grown on the surface thereof was obtained.

The particle size of the nickel particles carried on the silicon oxide particles was substantially the same as that of the iron particles in Example 1. The fiber diameter, the fiber length, and the weight proportion to the silicon oxide particles of the grown carbon nanofibers were substantially the same as those in Example 1. The SEM observations identified the presence of fine fibers having a diameter of 30 nm or less in addition to fibers having a diameter of approximately 80 nm. The crystal grain size of SiC also was the same as that of Example 1.

### EXAMPLE 3

The same operations as in Example 1 were carried out except that 0.5 g of iron nitrate nonahydrate and 0.5 g of nickel nitrate hexahydrate were dissolved in 100 g of ion-exchanged water in place of 1 g of iron nitrate nonahydrate. As a result, a composite negative electrode active material C of silicon oxide particles with accordion-shaped carbon nanofibers grown on the surface thereof was obtained.

The particle sizes of the iron particles and the nickel particles carried on the silicon oxide particles were both substantially the same as that of the iron particles in Example 1. The fiber diameter, the fiber length, and the weight proportion of the grown carbon nanofibers to the active material particles were substantially the same as those in Example 1. The SEM observations identified the presence of fine fibers having a diameter of 30 nm or less in addition to fibers having a diameter of approximately 80 nm. The crystal grain size of SiC also was the same as that of Example 1.

### EXAMPLE 4

The same operations as in Example 1 were carried out except that the composite negative electrode active material after the growth of carbon nanofiber was not baked in argon gas, whereby a composite negative electrode active material D was obtained. In an X-ray diffraction spectrometry of the composite negative electrode material D, no diffraction peak attributed to the (111) face of SiC was observed.

### EXAMPLE 5

The same operations as in Example 1 were carried out except that the composite negative electrode active material after the growth of carbon nanofiber was baked at 400° C. in argon gas, whereby a composite negative electrode active material E was obtained. The composite negative electrode active material E was then subjected to an X-ray diffraction spectrometry to determine a half-width of the diffraction peak attributed to the (111) face of SiC. The crystal grain size of SiC calculated using the half-width value and the Scherrer formula was 1 nm.

### EXAMPLE 6

The same operations as in Example 1 were carried out except that the composite negative electrode active material after the growth of carbon nanofiber was baked at 1400° C. in argon gas, whereby a composite negative electrode active material F was obtained. The composite negative electrode active material F was then subjected to an X-ray diffraction spectrometry to determine an half-width of the diffraction peak attributed to the (111) face of SiC. The crystal grain size of SiC calculated using the half-width value and the Scherrer formula was 100 nm.

### EXAMPLE 7

The same operations as in Example 1 were carried out except that the composite negative electrode active material after the growth of carbon nanofiber was baked at 1600° C. in argon gas, whereby a composite negative electrode active material G was obtained. The composite negative electrode active material G was then subjected to an X-ray diffraction spectrometry to determine a half-width of the diffraction peak attributed to the (111) face of SiC. The crystal grain size of SiC calculated using the half-width value and the Scherrer formula was 150 nm.

### EXAMPLE 8

The same operations as in Example 1 were carried out except that the growth time of the carbon nanofibers in the mixed gas composed of 50% by volume of hydrogen gas and 50% by volume of carbon monoxide gas was changed to 1 minute, whereby a composite negative electrode active material H was obtained. The carbon nanofibers grown on the surface of the silicon oxide particles had a fiber length of approximately 0.5 mm and a fiber diameter of approximately 80 nm. The amount of the grown carbon nanofibers was 1 parts by weight or less per 100 parts by weight of the silicon oxide particles. The crystal grain size of SiC was the same as that of Example 1.

### EXAMPLE 9

The same operations as in Example 1 were carried out except that the growth time of the carbon nanofibers in the mixed gas composed of 50% by volume of hydrogen gas and 50% by volume of carbon monoxide gas was changed to 5 minutes, whereby a composite negative electrode active material I was obtained. The carbon nanofibers grown on the surface of the silicon oxide particles had a fiber length of approximately 1 nm and a fiber diameter of approximately 80 nm. The amount of the grown carbon nanofibers was 5 parts by weight or less per 100 parts by weight of the silicon oxide particles. The crystal grain size of SiC was the same as that of Example 1.

### EXAMPLE 10

The same operations as in Example 1 were carried out except that the growth time of the carbon nanofibers in the mixed gas composed of 50% by volume of hydrogen gas and 50% by volume of carbon monoxide gas was changed to 10 hours, whereby a composite negative electrode active material J was obtained. The carbon nanofibers grown on the surface of the silicon oxide particles had a fiber length of approximately 1 mm and a fiber diameter of approximately 80 nm. The SEM observations identified the presence of fine fibers having a diameter of 30 nm or less in addition to fibers having a diameter of approximately 80 nm. The amount of the grown carbon nanofibers was 60 parts by weight per 100 parts by weight of the active material particles. The crystal grain size of SiC was the same as that of Example 1.

### EXAMPLE 11

The same operations as in Example 1 were carried out except that the growth time of the carbon nanofibers in the mixed gas composed of 50% by volume of hydrogen gas and 50% by volume of carbon monoxide gas was changed to 25 hours, whereby a composite negative electrode active material K was obtained. The carbon nanofibers grown on the surface of the silicon oxide particles had a fiber length of approximately 2 mm or more and a fiber diameter of approximately 80 nm. The SEM observations identified the presence of fine fibers having a diameter of 30 nm or less in addition to fibers having a diameter of approximately 80 nm. The amount of the grown carbon nanofibers was 120 parts by weight or more per 100 parts by weight of the active material particles. The crystal grain size of SiC was the same as that of Example 1.

### COMPARATIVE EXAMPLE 1

The silicon oxide particles pulverized to a particle size of 10 μm or less as used in Example 1 were used as they were to give a negative electrode active material L.

### COMPARATIVE EXAMPLE 2

The silicon oxide particles pulverized to a particle size of 10 μm or less as used in Example 1 in an amount of 100 parts by weight were dry mixed with 30 parts by weight of acetylene black (AB) as a conductive material to give a negative electrode active material M.

### COMPARATIVE EXAMPLE 3

In 100 g of ion-exchanged water, 1 g of iron nitrate nonahydrate was dissolved. The solution thus obtained was mixed with 5 g of acetylene black (AB). The mixture thus obtained was stirred for 1 hour, and then the water was removed with an evaporator to cause the acetylene black to carry iron nitrate particles. Then, the acetylene black carrying the iron nitrate particles was baked at 300° C. in air to give iron oxide particles having a particle size of 0.1 μm or less.

The iron oxide particles thus obtained were placed in a ceramic reaction vessel, and the temperature was raised to 500° C. in the presence of helium gas. Thereafter, the helium gas was replaced with a mixed gas composed of 50% by volume of hydrogen gas and 50% by volume of carbon monoxide gas. The interior of the reaction vessel was maintained at 500° C. for 1 hour to grow plate-shaped carbon nanofibers having a fiber diameter of approximately 80 nm and a fiber length of approximately 50 μm. Then, the mixed gas was replaced with helium gas and the interior of the reaction vessel was cooled down to room temperature.

The carbon nanofibers thus obtained were washed with aqueous hydrochloric acid solution to remove the ion particles, whereby carbon nanofibers that contained no catalyst element were obtained. Then, 30 parts by weight of the carbon nanofibers and 100 parts by weight of silicon oxide particles pulverized to a particle size of 10 μm or less as used in Example 1 were dry mixed to give a negative electrode material N.

### COMPARATIVE EXAMPLE 4

To 100 parts by weight of silicon oxide particles as used in Example 1, 0.02 part by weight of a chromium powder (mean particle size 100 μm) manufactured by Kanto Chemical Co., Inc. was added. The mixture thus obtained was mixed for 10 hours with a ball mill to give chromium-added silicon oxide particles.

Subsequently, 30 parts by weight of carbon nanofibers as used in Comparative Example 3 and 70 parts by weight of the chromium-added silicon oxide particles were mixed for 10 hours with a ball mill to obtain a mixture of the carbon nanofibers and the chromium-added silicon oxide particles.

The mixture thus obtained was placed in a ceramic reaction vessel, and the temperature was raised to 700° C. in the presence of helium gas. Thereafter, the helium gas was replaced with methane gas (100% by volume), and the interior of the reaction vessel was maintained at 700° C. for 6 hours. As a result, a carbon layer having a thickness of approximately 100 nm was formed on the surface of the silicon oxide particles. Then, the methane gas was replaced with helium gas, and the interior of the reaction vessel was cooled down to room temperature to give a composite negative electrode material O.

### COMPARATIVE EXAMPLE 5

The silicon oxide particles pulverized to a particle size of 10 μm or less as used in Example 1 were placed in a ceramic reaction vessel, and the temperature was raised to 1000° C. in the presence of helium gas. Thereafter, the helium gas was replaced with a mixed gas composed of 50% by volume of benzene gas and 50% by volume of helium gas. The interior of the reaction vessel was maintained at 1200° C. for 1 hour. As a result, a carbon layer having a thickness of approximately 500 nm was formed on the surface of the silicon oxide particles. Then, the mixed gas was replaced with helium gas and the interior of the reaction vessel was cooled down to room temperature to give a composite negative electrode active material P. The composite negative electrode active material P was then subjected to an X-ray diffraction spectrometry to determine a half-width of the diffraction peak attributed to the (111) face of SiC. The crystal grain size of SiC calculated using the half-width value and the Scherrer formula was 150 nm.

### EXAMPLE 6

The same operations as in Example 1 were carried out except that silicon particles (Si) pulverized to a particle size of 10 μm or less, manufactured by Kojundo Chemical Laboratory Co., Ltd. were used in place of silicon oxide particles pulverized to a particle size of 10 μm or less, whereby a composite negative electrode active material Q was obtained. As a result of analysis of Si used herein in accordance with the weight analysis method (JIS Z2613), it was found that the molar ratio of O/Si was 0.02 or less. The particle size of iron particles carried on the silicon particles was substantially the same as that in Example 1. The fiber diameter, the fiber length, and the weight proportion to the silicon oxide particles of the grown carbon nanofibers were also substantially the same as those in Example 1. The SEM observations identified the presence of fine fibers having a diameter of 30 nm or less in addition to fibers having a diameter of approximately 80 nm. The crystal grain size of SiC was the same as that of Example 1.

### EXAMPLE 7

The same operations as in Example 1 were carried out except that silicon dioxide particles (SiO₂) pulverized to a particle size of 10 μm or less, manufactured by Kojundo Chemical Laboratory Co., Ltd. were used in place of silicon oxide particles pulverized to a particle size of 10 μm or less, whereby a composite negative electrode active material R was obtained. As a result of analysis of Si used herein in accordance with the weight analysis method (JIS Z2613), it was found that the molar ratio of O/Si was 1.98 or more. The particle size of iron particles carried on the silicon dioxide particles was substantially the same as that in Example 1. The fiber diameter, the fiber length, and the weight ratio to the silicon oxide particles of the grown carbon nanofibers were also substantially the same as those in Example 1. The SEM observations identified the presence of fine fibers having a diameter of 30 nm or less in addition to fibers having a diameter of approximately 80 nm. The crystal grain size of SiC was the same as that of Example 1.

### EXAMPLE 8

Approximately 5 mm square tablets of silicon oxide (SiO) manufactured by Kojundo Chemical Laboratory Co., Ltd. were placed in an amount of approximately 50 g in a crucible made of tantalum (Ta), and then the crucible was set in a vacuum vapor deposition apparatus. The crucible was then heated to approximately 1700° C. in a vacuum atmosphere to form an SiO membrane having a thickness of approximately 10 μm on a 15 μm thick Cu foil by means of vapor deposition, whereby a negative electrode material S was obtained.

### [Evaluations]

Each of the composite negative electrode materials, negative electrode active materials or negative electrode materials produced in Examples 1 to 11 and Comparative Examples 1 to 7 was mixed in an amount of 100 parts by weight with 7 parts by weight of a binder of polyvinylidene fluoride and an appropriate amount of N-methyl-2-pyrrolidone (NMP) to prepare a negative electrode material mixture slurry. The each slurry thus obtained was cast on a 15 μm thick Cu foil and dried; thereafter the negative electrode material mixture was rolled to form a negative electrode material mixture layer. The electrode plates thus obtained were cut in a size of 3 cm×3 cm to give negative electrodes A to K of Examples 1 to 11 and negative electrodes L to R of Comparative Examples 1 to 7. The material mixture density of each of the obtained negative electrodes was 0.8 to 1.4 g/cm³. Herein, the negative electrode material S produced in Comparative Example 8 was used as it was as a negative electrode S after cut in a size of 3 cm×3 m.

The electrode plates thus obtained were sufficiently dried in an oven set at 80° C. to give working electrodes. By using a lithium metal foil as the counter electrode for each of the working electrodes, laminated lithium ion batteries each regulated by the working electrode were fabricated. As the non-aqueous electrolyte, there was used an electrolyte in which LiPF₆ was dissolved in a concentration of 1.0 M in a mixed solvent of ethylene carbonate and diethyl carbonate (1:1 by volume). The constitutions of the negative electrodes of Example 1 to 11 and Comparative Examples 1 to 8 are shown in Table 1.

TABLE 1

| | | | Negative | | | SiC | | | | |
|---|---|---|---|---|---|---|---|---|---|---|
| | | | electrode | | Baking | crystal | | | | |
| | Evaluation | Negative | active | Catalyst | temperature | grain | | CNF | | Conductive |
| | item | electrode | material | type | (in Ar) | size | | length | | material |
| Ex. 1 | Catalyst type | A | SiO | Fe | 1000° C. | 30 | nm | 50 | μm | CNF |
| Ex. 2 | | B | SiO | Ni | 1000° C. | 30 | nm | 50 | μm | CNF |
| Ex. 3 | | C | SiO | FeNi | 1000° C. | 30 | nm | 50 | μm | CNF |
| Ex. 4 | SiC crystal | D | SiO | Fe | — | — | | 50 | μm | CNF |
| Ex. 5 | grain size | E | SiO | Fe | 400° C. | 1 | nm | 50 | μm | CNF |
| Ex. 6 | | F | SiO | Fe | 1400° C. | 100 | nm | 50 | μm | CNF |
| Ex. 7 | | G | SiO | Fe | 1600° C. | 150 | nm | 50 | μm | CNF |
| Ex. 8 | CNF length | H | SiO | Fe | 1000° C. | 30 | nm | 0.5 | nm | CNF |
| Ex. 9 | | I | SiO | Fe | 1000° C. | 30 | nm | 1 | nm | CNF |
| Ex. 10 | | J | SiO | Fe | 1000° C. | 30 | nm | 1 | mm | CNF |
| Ex. 11 | | K | SiO | Fe | 1000° C. | 30 | nm | 2 | mm | CNF |
| Com. Ex. 1 | Conductive | L | SiO | — | — | — | | — | | — |
| Com. Ex. 2 | material | M | SiO | — | — | — | | — | | AB |
| Com. Ex. 3 | | N | SiO | — | — | — | | 50 | μm | CNF |
| Com. Ex. 4 | Ball mill | O | SiO | — | — | — | | 50 | μm | CNF |
| Com. Ex. 5 | Carbon coating | P | SiO | — | — | 150 | nm | — | | — |
| Com. Ex. 6 | Material | Q | Si | Fe | 1000° C. | 30 | nm | 50 | μm | CNF |
| Com. Ex. 7 | | R | SiO₂ | Fe | 1000° C. | 30 | nm | 50 | μm | CNF |

| | | | | | | | | |
|---|---|---|---|---|---|---|---|---|
| Com. Ex. 8 | Thin membrane | S | SiO | — | — | — | — | — |

### (Initial Discharge Capacity and Initial Charge/Discharge Efficiency)

With regard to the obtained laminated lithium ion batteries, an initial discharge capacity and an initial charge/discharge capacity were measured at a charge/discharge speed of 0.05 C. The measured initial discharge capacities are shown in Table 2. Further, the proportion of the initial discharge capacity to the initial charge capacity was calculated as a percentage to obtain an initial charge/discharge efficiency. The results are shown in Table 2.

### (Initial Discharge Efficiency)

With regard to the obtained laminated lithium ion batteries, charging was carried out at a speed of 0.2 C, and then discharging was carried out at speeds of 1.0 C and 2.0 C. The proportion of the 2.0 C discharge capacity to the 1.0 C discharge capacity was calculated as a percentage to obtain an initial discharge efficiency value. The results are shown in Table 2.

### (Cycle Efficiency)

With regard to the obtained laminated lithium ion batteries, an initial discharge capacity and a discharge capacity after the charge/discharge operation was repeated for 200 cycles were measured at a charge/discharge speed of 0.2 C. The proportion of the discharge capacity after 200 cycles to the initial discharge capacity was calculated as a percentage to obtain a cycle efficiency. The results are shown in Table 2.

### (Gas Generation Amount)

With regard to the obtained laminated lithium ion batteries, charging was carried out at a charge speed of 0.2 C, and then the batteries were stored in a charged state at 60° C. for 14 days. The stored batteries were then cooled down to room temperature to measure gas generation amount of each battery with a gas analysis method. The results are shown in Table 2.

TABLE 2

| | | | | | Initial | | | |
|---|---|---|---|---|---|---|---|---|
| | | | Initial | | charge/ | Initial | | Gas |
| | Evaluation | Negative | discharge | | discharge | discharge | Cycle | generation |
| | item | electrode | capacity | | efficiency | efficiency | efficiency | amount |
| Ex. 1 | Catalyst | A | 1005 | mAh/g | 72% | 85% | 82% | 0.2 ml |
| Ex. 2 | type | B | 1002 | mAh/g | 73% | 84% | 83% | 0.2 ml |
| Ex. 3 | | C | 1001 | mAh/g | 72% | 85% | 83% | 0.2 ml |
| Ex. 4 | SiC crystal | D | 1002 | mAh/g | 60% | 83% | 70% | 0.2 ml |
| Ex. 5 | grain size | E | 1003 | mAh/g | 67% | 84% | 78% | 0.2 ml |
| Ex. 6 | | F | 1002 | mAh/g | 78% | 82% | 80% | 0.2 ml |
| Ex. 7 | | G | 920 | mAh/g | 80% | 65% | 85% | 0.2 ml |
| Ex. 8 | CNF length | H | 1131 | mAh/g | 72% | 50% | 55% | 0.2 ml |
| Ex. 9 | | I | 1070 | mAh/g | 72% | 66% | 68% | 0.2 ml |
| Ex. 10 | | J | 913 | mAh/g | 70% | 90% | 85% | 0.2 ml |
| Ex. 11 | | K | 853 | mAh/g | 70% | 92% | 87% | 0.2 ml |
| Com. Ex. 1 | Conductive | L | 150 | mAh/g | 10% | 20% | 0% | 1.0 ml |
| Com. Ex. 2 | material | M | 652 | mAh/g | 23% | 28% | 3% | 0.8 ml |
| Com. Ex. 3 | | N | 823 | mAh/g | 35% | 35% | 5% | 0.1 ml |
| Com. Ex. 4 | Ball mill | O | 842 | mAh/g | 40% | 42% | 15% | 0.2 ml |
| Com. Ex. 5 | Carbon coating | P | 850 | mAh/g | 65% | 75% | 20% | 0.5 ml |
| Com. Ex. 6 | Material | Q | 3830 | mAh/g | 87% | 82% | 40% | 0.3 ml |
| Com. Ex. 7 | | R | 0 | mAh/g | — | — | — | — |
| Com. Ex. 8 | Thin membrane | S | 1280 | mAh/g | 71% | 80% | 63% | 1.1 ml |

As shown in Table 2, differences due to differences in the types of catalyst element (catalyst types) were not identified in the batteries utilizing the electrodes A to K produced in Examples 1 to 11. Any of Examples was superior to Comparative Example 1 that contains no carbon nanofibers, with respect to all of the initial charge/discharge efficiency, the initial discharge efficiency, the cycle efficiency, and the gas generation amount.

In Comparative Example 1, it is considered that the electronically conductive network among the active material particles was broken instantly due to the expansion of the active material caused by initial charge/discharge. Because of this, the values of the initial charge/discharge efficiency and the initial discharge capacity were low. Further, with regard to the batteries of Examples 1 to 11 after the measurement of gas generation amount, the surfaces of the carbon nanofibers were analyzed with X-ray diffraction, XPS or the like. As a result, a small amount of Li₂SiF₆ was found. This identified that the hydrogen fluoride in the batteries was trapped by the carbon nanofibers, resulting in suppression of gas generation.

With regard to the batteries of Comparative Examples 2 and 3, in which the carbon nanofibers and acetylene black were dry mixed with the silicon oxide particles, steep degradations were found in the initial charge/discharge efficiency and the cycle efficiency, compared with the batteries of Examples 1 to 11. Further, in the battery of Comparative Example 4, in which the silicon oxide particles were mixed with the carbon nanofibers with a ball mill, steep degradation was also found in the initial charge/discharge efficiency and the cycle efficiency compared with the batteries of Examples 1 to 11. This is ascribable to the fact that the electronically conductive network between the surface of the active material particles and the carbon nanofibers was broken due to the expansion and contraction of the active material caused every charge/discharge operation. It was further found in the battery using acetylene black as a conductive material that the gas generation amount was increased.

Also with regard to the battery of Comparative Example 5, in which the surface of the silicon oxide particles was coated with a carbon layer, steep degradation was found in the initial charge/discharge efficiency and the cycle efficiency, compared with the batteries of Examples 1 to 11. This is ascribable to the fact that the electronically conductive network among the active material particles was broken due to the expansion and contraction of the active material caused by charge/discharge. Further, the gas generation amount of this battery was higher than those of the batteries containing the carbon nanofibers.

With regard to the battery of Comparative Example 6, in which silicon particles were used in place of silicon oxide particles, the initial discharge capacity was relatively high, but the cycle degradation was observed. Absorption of lithium expands the volume of the elementary silicon by a factor of four or more. It is considered therefore that the particles themselves to which the carbon nanofibers were bonded were crushed. This results in breaking of the bonds between the carbon nanofibers and the surface of the active material, resulting in cycle degradation.

It should be noted that with regard to the battery of Comparative Example 7, in which silicon dioxide particles were used, it did not function at all as a battery since silicon dioxide itself is electrochemically inactive.

With regard to a battery using the negative electrode material of Comparative Example 8, on which a vapor deposition membrane of silicon oxide was formed, it was found that the cycle efficiency was decreased and the gas generation amount after stored at 60° C. was increased. It was observed that the negative electrode after 200 cycles had visible wrinkles and the silicon oxide was partly dropped from the current collector. The gas generation during storage is presumably attributable to the hydrogen fluoride contained in the electrolyte in view of the fact that Li₂SiF₆ was not detected in the battery.

With regard to the battery using the composite negative electrode active material obtained in Example 4, in which baking after the growth of carbon nanofiber was not carried out, the initial charge/discharge efficiency and the cycle efficiency were reduced, compared with those of Examples to 3 and 5 to 7. The reduction in the initial charge/discharge efficiency is ascribable to the fact that the hydrogen ions and the functional groups such as methyl groups and hydroxyl groups adhering to the surface of the carbon nanofibers were not removed to cause an irreversible reaction with the electrolyte. Moreover, the reduction in the cycle characteristics is ascribable to the fact that the silicon oxide and the carbon nanofibers are not directly chemically bonded. It is considered therefore that the connections between the surface of the silicon oxide and the carbon nanofibers were gradually broken as the charge/discharge cycle was proceeded.

With regard to the battery using the composite negative electrode active material obtained in Example 7, in which baking after the growth of carbon nanofiber was carried out at 1600° C., the initial discharge capacity was reduced, compared with those of Examples 1 to 6. In this case, the hydrogen ions and the functional groups such as methyl groups and hydroxyl groups adhering to the surface of the carbon nanofibers were completely removed. However, the silicon oxide and the carbon react with each other to produce a great amount of electrochemically inactive silicon carbide, and this caused reduction in the initial discharge capacity.

With regard to the battery using the composite negative electrode active material obtained in Example 8, in which the carbon nanofibers were grown as short as 0.5 mm in length, the cycle characteristics were reduced, compared with those of Examples 1 to 3 and 9 to 11. It is conceivable that the conductivity was maintained in the initial charge/discharge by virtue of the carbon nanofibers formed on the surface of the active material, but the conductivity among the particles was lost gradually due to the repeated expansion and contraction of the active material caused by charge and discharge.

To the contrary, with regard to the battery using the composite negative electrode active material obtained in Example 11, in which the carbon nanofibers were grown long, both the initial charge/discharge efficiency and the cycle efficiency were at the same levels as in Examples 1 to 3, 9 and 10. However, reduction was observed only in the discharge capacity. This is ascribable to the fact that the proportion of the carbon nanofibers in the negative electrode was relatively increased in relation to the amount of the active material.

### EXAMPLE 12

In 100 g of ion-exchanged water, 1 g of nickel nitrate hexahydrate (guaranteed grade) manufactured by Kanto Chemical Co., Inc. was dissolved. The solution thus obtained was mixed with 100 g of silicon oxide particles (the molar ratio of O/Si was 1.01) as used in Example 1. The mixture thus obtained was stirred for 1 hour, and then the water was removed with an evaporator to give active material particles each composed of silicon particles as an electrochemically active phase and nickel nitrate carried on the surface of the silicon particles.

The active material particles carrying nickel nitrate were placed in a ceramic reaction vessel, and the temperature was raised to 540° C. in the presence of helium gas. Thereafter, the helium gas was replaced with a mixed gas composed of 20% by volume of hydrogen gas and 80% by volume of ethylene gas. The interior of the reaction vessel was maintained at 540° C. for 1 hour. As a result, herringbone-shaped carbon nanofibers having a fiber diameter of approximately 80 nm and a fiber length of approximately 50 μm were grown on the surface of the silicon oxide particles. Then, the mixed gas was replaced with helium gas and the interior of the reaction vessel was cooled down to room temperature. The amount of the grown carbon nanofibers was 30 parts by weight per 100 parts by weight of the active material particles. In this case also the SEM observations identified the presence of fine fibers having a diameter of 30 nm or less in addition to fibers having a diameter of approximately 80 nm.

Thereafter, the composite negative electrode active material of the silicon oxide particles with the carbon nanofibers bonded thereto was heated to 1000° C. in argon gas, and then baked at 1000° C. for 1 hour. The composite negative electrode active material thus obtained was then subjected to an X-ray diffraction spectrometry to determine a half-width of the diffraction peak attributed to the (111) face of SiC. The crystal grain size of SiC calculated using the half-width value and the Scherrer formula was 20 nm.

### [Evaluation]

The electrode material produced in Example 12 was used to fabricate a negative electrode of the same type as in Example 1. Lithium was imparted onto the negative electrode thus obtained in an amount corresponding to the irreversible capacity by use of a lithium vapor deposition apparatus based on resistance heating.

A positive electrode material mixture slurry was prepared by mixing together 100 parts by weight of LiNi_{0.8}Cu_{0.17}Al_{0.03}O₂, 10 parts by weight of a binder of polyvinylidene fluoride, 5 parts by weight of carbon black and an appropriate amount of N-methyl-2-pyrrolidone (NMP). The slurry thus obtained was cast on an Al foil having a thickness of 15 μm and dried; thereafter the positive electrode material mixture was rolled, whereby a positive electrode material mixture layer was formed. The electrode plate thus obtained was cut in a size of 3 cm×3 cm to give a positive electrode.

A battery was fabricated in the same manner as in Example 1 except that there were used the thus obtained negative electrode into which lithium was introduced and the thus obtained positive electrode which contained LiNi_{0.8}Co_{0.17}Al_{0.03}O₂ as the positive electrode active material, and the battery was evaluated in the same manner as in Example 1. The evaluation results revealed that the initial discharge capacity per the weight of the negative electrode active material was 1007 mAh/g, the discharge efficiency was 85%, the cycle efficiency was 89% and the gas generation amount was 0.2 ml.

The method for introducing lithium into the negative electrode applicable hereto is not limited to the above; and the method includes, for example, a method of bonding lithium foil onto the negative electrode to thereafter assemble a battery, or introducing lithium powder into the interior of a battery.

### EXAMPLE 13

The same operations as in Example 12 were carried out except that the carbon nanofibers were grown on the surface of the silicon oxide particles in the mixed gas composed of 20% by volume of hydrogen gas and 80% by volume of methane gas at a reaction temperature of 900° C. for a reaction time of 0.5 hour. As a result, tubular carbon nanofibers having a fiber diameter of approximately 80 nm and a fiber length of approximately 50 μm were grown on the surface of the silicon oxide particles. The amount of the grown carbon nanofibers was 100 parts by weight per 100 parts by weight of the active material particles. The SEM observations identified the presence of fine fibers having a diameter of 20 nm or less in addition to fibers having a diameter of approximately 80 nm. The crystal grain size of SiC was 10 nm.

### [Evaluation]

The electrode material produced in Example 13 was used to fabricate a negative electrode of the same type as in Example 1. Lithium was imparted onto the negative electrode thus obtained in an amount corresponding to the irreversible capacity by use of a lithium vapor deposition apparatus based on resistance heating. A battery was fabricated in the same manner as in Example 1 except that there were used the thus obtained negative electrode into which lithium was introduced and the positive electrode of the same type as in Example 12, and the battery was evaluated in the same manner as in Example 1. The evaluation results revealed that the initial discharge capacity per the weight of the negative electrode active material was 1002 mAh/g, the discharge efficiency was 82%, the cycle efficiency was 80% and the gas generation amount was 0.2 ml.

### INDUSTRIAL APPLICABILITY

The composite negative electrode active material according to the present invention is useful as a negative electrode active material for a non-aqueous electrolyte secondary battery that is expected to have high capacity. The composite negative electrode active material according to the present invention is particularly high in electron conductivity and is preferably applicable for a negative electrode active material for use in a non-aqueous electrolyte secondary battery that is required to be excellent in initial charge/discharge characteristics and cycle characteristics, and be highly reliable due to reduced gas generation.

1. A composite negative electrode active material comprising silicon oxide particles represented by SiOₓ (0.05<x<1.95), carbon nanofibers bonded to the surface of said silicon oxide particles and a catalyst element for promoting the growth of carbon nanofiber.

2. The composite negative electrode active material in accordance with claim 1, wherein said catalyst element is at least one selected from the group consisting of Au, Ag, Pt, Ru, Ir, Cu, Fe, Co, Ni, Mo and Mn.

3. The composite negative electrode active material in accordance with claim 1, wherein said catalyst element is carried on said silicon oxide particles.

4. The composite negative electrode active material in accordance with claim 1, wherein one end of said carbon nanofibers is bonded to the surface of said silicon oxide particles and the other end of said carbon nanofibers carries said catalyst element.

5. The composite negative electrode active material in accordance with claim 1, wherein one end of said carbon nanofibers is bonded to Si on the surface of said silicon oxide particles to form SiC.

6. The composite negative electrode active material in accordance with claim 5, wherein a crystal grain size of SiC is 1 to 100 nm.

7. The composite negative electrode active material in accordance with claim 1, wherein said catalyst element is present in a state of a metal particle and/or a metal oxide particle having a particle size of 1 nm to 1000 nm in the surface layer of said silicon oxide particles.

8. The composite negative electrode active material in accordance with claim 1, wherein said carbon nanofibers have a fiber length of 1 nm to 1 mm.

9. The composite negative electrode active material in accordance with claim 1, wherein said carbon nanofibers comprise fibers having a diameter of 1 nm to 40 nm.

10. The composite negative electrode active material in accordance with claim 1, wherein said carbon nanofibers comprise at least one selected from the group consisting of tubular carbon, accordion-shaped carbon, plate-shaped carbon and herringbone-shaped carbon.

11. A method for producing a composite negative electrode active material, the method comprising steps of:
A) causing silicon oxide particles represented by SiOₓ (0.05<x<1.95) to carry a catalyst element for promoting the growth of carbon nanofiber;
B) growing carbon nanofibers on the surface of said silicon oxide particles carrying said catalyst element in an atmosphere comprising a carbon-containing gas; and
C) baking said silicon oxide particles with said carbon nanofibers bonded thereto at 400° C. or higher and 1400° C. or lower in an inert gas atmosphere.

12. The method for producing a composite negative electrode active material in accordance with claim 11, wherein said catalyst element is at least one selected from the group consisting of Au, Ag, Pt, Ru, Ir, Cu, Fe, Co, Ni, Mo and Mn.

13. The method for producing a composite particle for an electrode in accordance with claim 11, wherein said catalyst element is Ni, said carbon-containing gas is ethylene, and said carbon nanofibers are of a herringbone shape.

14. A non-aqueous electrolyte secondary battery comprising a negative electrode comprising the composite negative electrode active material in accordance with claim 1, a positive electrode capable of charge and discharge, a separator interposed between said positive electrode and said negative electrode, and a non-aqueous electrolyte.
